(19) United States
(12) Patent Application Publication
(10) Pub. No.: US 2020/0091990 A1
(43) Pub. Date: Mar. 19, 2020

(54) MULTI-BAND ANTENNA ARRANGEMENTS

(71) Applicant: Amphenol Antenna Solutions, Inc., Rockford, IL (US)

(72) Inventor: Jimmy HO, Hickory, NC (US)

(21) Appl. No.: 16/575,060

(22) Filed: Sep. 18, 2019

Related U.S. Application Data
(60) Provisional application No. 62/732,850, filed on Sep. 18, 2018.

(51) Int. Cl. H04B 7/155; H01Q 1/22; H01Q 1/24; H01Q 21/00; H01Q 1/00; H01Q 21/06; H01Q 21/30

(52) U.S. Cl. CPC H04B 7/15507; H01Q 1/2291; H01Q 1/246; H01Q 21/30; H01Q 1/007; H01Q 21/062; H01Q 21/0087

(57) ABSTRACT

An antenna array assembly has a plurality of first radiating elements and associated first electronic circuit arrangements operational in at least an upper frequency range, and a conductive plane formed by a second radiating element operational in a lower frequency range. The conductive plane functions as a reflective groundplane for the first antenna array.

### RELATED APPLICATIONS

This application claims the benefit of U.S. Provisional Application No. 62/732,850, filed Sep. 18, 2018, the entire content of which is incorporated herein by reference.

### FIELD OF THE DISCLOSURE

The present disclosure relates to wireless communication systems and in particular to antenna arrangements for base stations, repeaters and access points operating in both sub-6-GHz frequency bands and millimeter-wave frequency bands and provides a compact arrangement by overlaying highly directive microwave antennas onto sub-6-GHz antennas.

### BACKGROUND

Many services provided by the fifth generation of mobile radio systems rely on the use of frequency bands in the microwave region of the radio spectrum. Microwave radio systems have the advantage of providing very large user bandwidths and correspondingly high rates of data transmission. But the propagation characteristics of microwave radio are more similar to optical propagation and it is necessary to have an unobstructed path between user equipment and the base station that serves it. To extend microwave coverage into buildings, it is desirable to provide a small low-power relay device that receives transmissions from outside the building and re-transmit the signal inside the building.

Frequency bands in use for mobile radio services, including WiFi services have, prior to the introduction of 5^{th}-Generation (5G) services, been below 6 GHz. The introduction of 5G has brought much higher frequencies into use at which antenna elements are far smaller than heretofore. Even complete multi-element antenna arrays are small compared with a single radiating element at lower frequencies. The term “sub-6-GHz” is used below to refer to the lower frequency bands in use for generations of mobile radio services prior to 5G.

Mobile radio services of earlier generations (2, 3 and 4) have made use of “picocells” providing local coverage in unserved areas, whereas SGNR (New Radio) utilizes microwave frequency bands. Many 5GNR services are expected to operate in frequency bands above 26 GHz, often referred to as millimeter-wave bands.

Repeaters are commonly employed to extend and add coverage to areas that are blocked by buildings/trees/obstacles. This is especially true for millimeter-wave signals where propagation losses are high and penetration through obstacles such as window glass is not possible.

European Patent Application EP2851993A1 describes an integrated window antenna for wireless communication whereby an antenna structure is printed on a glass panel/s with the window itself serving as a carrier medium. The concept is similar to printing elements on a PCB substrate and then putting them inside an antenna enclosure. The difference here is that the EP '993 application prints them on a window pane with the metal traces sandwiched between the surface of the window and a dielectric substrate on which the traces are etched. In one embodiment of the EP '993 application, a patch antenna is metalized on one side of the window pane and a reflector is metalized on their other side. In another embodiment, several window panes are used with the reflector in the middle to allow for an aperture coupled solution. U.S. Pat. No. 8,634,764 discloses a repeater system with integrated antenna in a glass pane. Similar to EP2851993A1, where the radiating elements are etched on a substrate and then applied to the glass on the window, the '764 patent goes one step further by having an outside antenna array printed on a window pane above a ground plane and then another antenna on the inside of the building on a separate ground plane. If multiple bands are used, then the occupied space for the arrangement becomes quite large.

However, as the EP '993 application points out, many glass panes are thick and have absorbing properties, both of which are detrimental to millimeter-wave antenna arrays. The window thickness needs to be small to prevent higher order transversal modes, and the glass absorbs millimeter-wave wave signals. U.S. Pat. No. 8,634,764 also discloses an outside antenna array printed on a window pane above a ground plane and a second antenna on the inside of the building on a second ground plane. If multiple bands are used, the occupied space becomes quite large.

FIG. 1 shows a window overlay repeater according to the '764 patent. In this arrangement, conductive antenna elements and a radio frequency feed network are formed on a first face of an insulating panel, typically window pane. A conductive groundplane is formed on a second face. An antenna on an outside face receives signals from a base station, by a radio frequency feed network. This antenna transfers the signal to a second antenna facing the interior of the building by way of a bidirectional amplifier. The antenna inside the building may be the same as the outside antenna that is formed above a ground plane.

FIG. 2 illustrates a base station 1 transmitting a directional millimeter-wave radio signal 2 towards a building 4. On passing through a typical window 3 the radio signal is attenuated and a much weakened signal 5 is received within the building. The attenuation of glass windows increases with increasing frequency of a radio signal and can be greatly increased if the window has double or triple layers of glass, and/or has a reflective coating intended to reduce the transmission of heat into the building. At millimeter-wave frequencies very little signal may penetrate the window, resulting in no coverage inside the building, even in positions close to an outside window.

FIG. 3 indicates a base station 1 transmitting a millimeter-wave signal 2 and sub-6-GHz signal 7 to a window pane 3 of building 4. A strong millimeter-wave signal 8 and a strong sub-6-GHz signal 9 are required within the building to achieve reliable coverage and communication. Because of the radio frequency properties of the window, which both reflects and absorbs signals in both directions, this may not be achievable, especially for millimeter-wave signals.

### SUMMARY

In some embodiments millimeter-band antenna arrays, optionally together with associated electronic circuit arrangements, are positioned on planar dipole elements operating in sub-6-GHz frequency ranges. By way of example, implementations are described in which antennas operating in both frequency ranges are arranged on window panes to provide enhanced in-building service.

The direction of the beams formed by the millimeter-wave arrays may be chosen to be orthogonal to the plane of the window pane, or may be adjusted in direction by arranging appropriate phase shifts between the elements forming the arrays, as is familiar to a skilled person. This adjustment may be chosen independently by design for the external and internal arrays. If a plurality of millimeter-wave arrays is provided, the direction of beams formed by each array may be chosen to differ in order to provide separate areas of coverage within the building and/or to provide connection to more than one base station.

The shortage of available accommodation for antennas at existing base stations together with planning and other constraints on the installation of new base stations create a requirement for compact base station antennas. These must combine facilities on an increasing number of frequency ranges and must be suitable for installation in a wide variety of physical and electromagnetic environments. Examples are windows in homes and offices, urban buildings of architectural significance where installations much be small and unobtrusive, and public buildings such as airports and sports stadiums where extreme capacity must be provided to a very large number of concurrent users.

The quest for more compact base station arrangements has led to the increased integration of antennas and the inclusion therewith of electronic and other circuit devices including but not limited to power amplifiers, low-noise amplifiers, bidirectional amplifiers, signal processing devices, signal conditioning, filtering and control functionalities. Any subset of these is described herein below as electronic circuit arrangements.

Many prior art antenna arrangements providing operation in multiple frequency ranges rely on the harmonic relationship between the frequencies used for mobile radio. One object of the present disclosure is an arrangement whereby antennas for frequency ranges having a substantial and even a non-integer ratio between them can be accommodated within the space usually occupied by the antenna (or antenna array) operating in the lower of the required frequency ranges.

For the sake of clarity, the upper frequency range is referred to herein as a millimeter-wave frequency and the lower frequency as a sub-6-GHz frequency, but the disclosure is applicable wherever there is a substantial ratio between the frequencies involved. In one embodiment, sub-6 GHz can be approximately 30 kHz-6 GHz, and more typically fur the base station industry, sub-6 GHz refers to the frequency range 600 MHz-6 GHz. For millimeter wave, the range is approximately 30 GHz-300 GHz, and more specifically for 5G, millimeter wave frequencies include 26 GHz-300 GHz. Of course, the disclosure can be utilized with other suitable frequencies.

5G provides for operation of a wide variety of different services. Coverage of users will require wide area coverage in sonic frequency ranges and narrow intelligently-controlled beams in other frequency ranges. These require a wide variety of antennas having different characteristics in terms of radiation patterns, frequency and power ratings, often for the antennas forming a single base station. The disclosure is directed at solutions for such requirements.

The data connections between the fixed telecommunications network and mobile radio networks (“back-haul”) are frequently realized by using microwave radio links. The disclosure can distribute data within high-capacity millimeter-wave radio services as part of 5G systems, both as backhaul links to the fixed network and also as “front-haul” links between network switching facilities. It will also permit the development of simplified base stations having lower levels of processing capability and cost than present base stations. Some of the antenna arrangements described below are very suitable for use for relaying user data to provide extended coverage as well as for performing front-haul and back-haul functions.

In an example of the present disclosure, the window pane is used to support a repeater, in which a millimeter-wave solution for high data rate communication shares the same area as a sub-6-GHz solution used in today's mobile communications, providing a compact combined antenna solution supporting both sub-6-GHz frequency bands and new millimeter-wave bands as used by 4G and 5G radio systems.

### BRIEF DESCRIPTION OF THE DRAWINGS

For better understanding of the disclosure and to show how it may be carried into effect, there will now be described by way of example only, specific embodiments methods and processes according to the present disclosure, with reference to the accompanying drawings in which:

FIG. 1 is a diagram showing the prior art arrangement of a window overlay antenna repeater,

FIG. 2 is a diagram showing a millimeter-wave beam from a base station directed at a window and showing by way of example, only a small beam with very little coverage that is passed through the window due to high propagation losses.

FIG. 3 is a diagram showing a sub-6 GHz and millimeter-wave signal sent from a base station to the window and showing the ideal signal level and area of coverage that is required within a building.

FIG. 4 shows two millimeter-wave antenna arrays mounted on a first conductive strip resonant in a sub-6-GHz frequency range and having feeding arrangements on a second conductive strip orthogonal to the first conductive strip.

FIG. 5(a) is a plan view that illustrates an arrangement providing two millimeter-wave antenna arrays supported by a dipole element having a Roberts' balun operative in a sub-6-GHz frequency range.

FIG. 5(b) is a front view of the arrangement of FIG. 5(a).

FIG. 5(c) is a rear view of the arrangement of FIG. 5(a).

FIG. 6(a) shows a front elevation view of four millimeter-wave antenna arrays supported by a sub-6-GHz crossed dipole antenna.

FIG. 6(b) is a plan view of the arrays of FIG. 6(a).

FIG. 7(a) is a front view of two millimeter-wave antennas supported by a sub-6-GHz dipole antenna formed on a thin substrate suitable for attachment to a window pane.

FIG. 7(b) is a plan view of the antennas of FIG. 7(a).

FIGS. 8(a), (b) illustrate 3-D radiation patterns of a sub-6-GHz dipole antenna fed against a ground conductor embedded in a window frame.

FIG. 9(a) is a front view of two millimeter-wave arrays supported by a sub-6-GHz dipole element shunt excited by a notch.

FIG. 9(b) is a rear view of the arrays of FIG. 9(a).

FIG. 9(c) is an edge view of the arrays of FIG. 9(a).

FIGS. 10(a), 10(b), 10(c) show examples of radiation patterns provided by millimeter-wave antenna arrays configured according to the disclosure using beam-steering/beam-forming by electronic phase shifters and/or amplifiers.

FIG. 11 shows a different example of sub-6-GHz and millimeter-wave antenna arrays with their supported patterns in which the sub-6-GHz radiated beams, before applying beam steering, lie substantially in the same azimuth direction as the millimeter-wave beams.

FIG. 12 shows an example of a base station antenna with sub-6-GHz array projecting a broad directional beam downwards by between 5 and 20 degrees below the horizontal and millimeter-wave arrays with beams directed at current users and capable of being redirected or divided according to user demand for service. In this example the sub-6-GHz radiated beams, before applying beam steering, lie substantially orthogonal in the azimuth direction to the millimeter-wave beams.

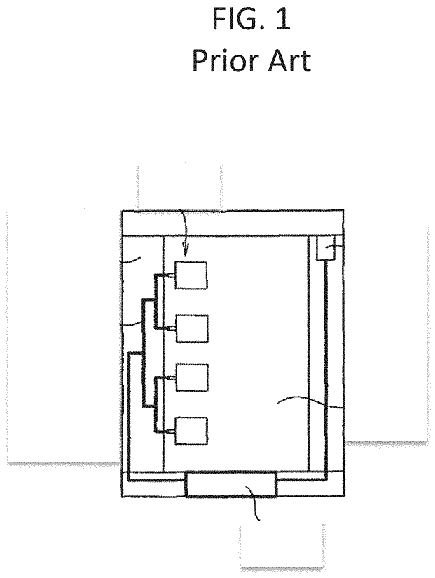

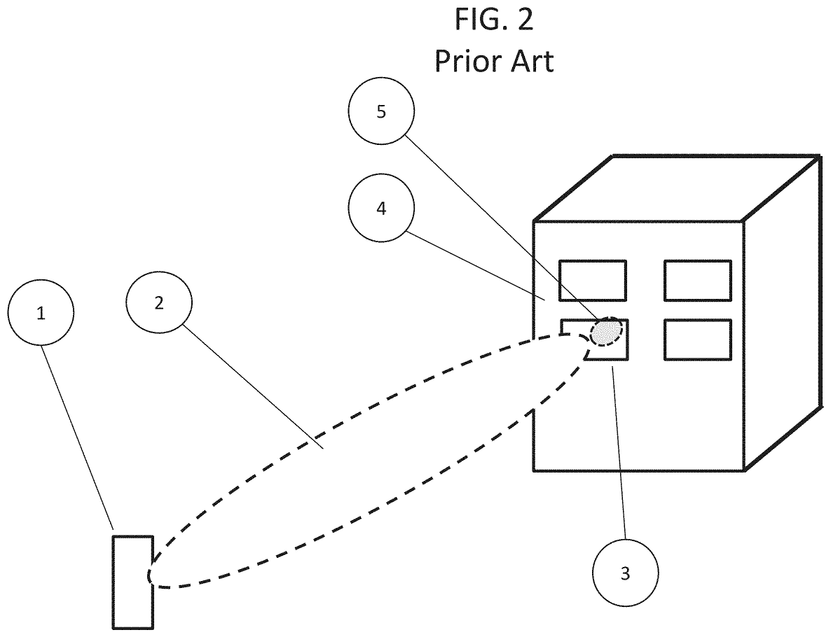

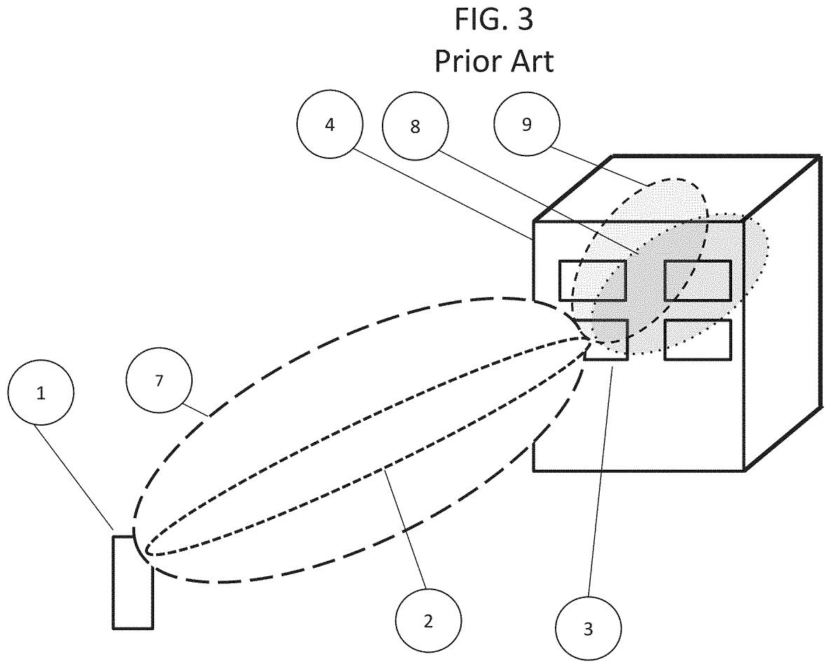

### DETAILED DESCRIPTIONS OF PREFERRED EMBODIMENTS

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments are described for illustrative purposes, it being understood that the description and claims are not limited to the illustrated embodiments and other embodiments not specifically shown in the drawings may also be within the scope of this disclosure.

The operation of radio systems and antennas is bidirectional, providing for both the transmission and reception of radio signals. In the following description, references to the transmission of signals shall be taken to include their reception and vice versa.

Base stations for mobile radio services typically transmit and receive signals having 45-degree slant linear polarization. For the sake of simplicity, dipole elements are illustrated herein as having horizontal polarization, but it will be understood that by orienting dipoles appropriately they may have slant or vertical polarization. Crossed dipole or patch elements may be used in place of horizontal dipoles to provide dual slant polarization or circular polarization.

The term radiating element refers to a simple device such as a dipole or slot whose function is to transmit or receive radio waves. An antenna array comprises a plurality of radiating elements whose inputs are combined to provide increased directivity and gain relative to a single radiating

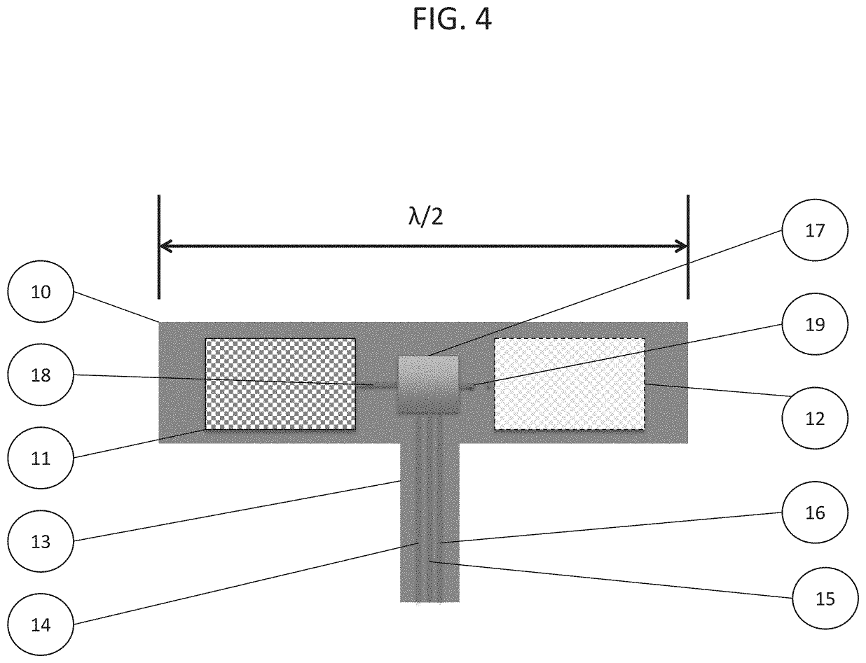

FIG. 4 shows a first embodiment of the disclosure in which millimeter-wave antenna arrays 11, 12 are provided on an elongate planar conductive member 10, substantially one-half wavelength in length at a sub-6-GHz operating frequency band. A second elongate conductive member 13 is connected to the midpoint of a long edge of conductor 10 and perpendicular thereto, thereby providing a means by which one or more of each of microstrip lines 14, power feeds 15 and data connections 16 may be made to electronic circuit arrangements 17. The circuit arrangements 17 are located between millimeter-wave antenna arrays 11 and 12 and are connected thereto by transmission lines 18, 19. In one embodiment of the disclosure, the arrangement of FIG. 4 can be applied to a window pane, for example by means of double-sided pressure sensitive adhesive tape. The conductive member 10 may be formed by a printed circus process on a flexible substrate such as polyimide film having a typical thickness of 80 μm or a rigid PTFE-glass or resin-glass substrate having a thickness typically between 0.3 mm and 1.6 mm.

Millimeter-wave array 11 is arranged on a first face of the conductive strip 10. Millimeter-wave array 12 may be arranged on the first face or optionally on a second face (on an opposite side of the first face) of conductive strip 10 as shown in FIG. 4. The conductive strip 10 scatters incoming sub-6-GHz signals thereby increasing signal levels in areas inside the building which may be not be illuminated by the direct sub-6-GHz signal passing through the window.

The direction of maximum radiation (beam direction) of each of the millimeter-wave antenna arrays 11, 12 may be fixed by design or may be controlled by electronic circuit arrangements 17, optionally in response to signals from user equipment and/or by external signals provided by control circuit arrangements and transmitted to the circuit arrangements 17 by the data connection 16. The millimeter-wave arrays 11, 12, together with circuit arrangements 17 may provide MIMO or other advanced signal control and processing functionalities.

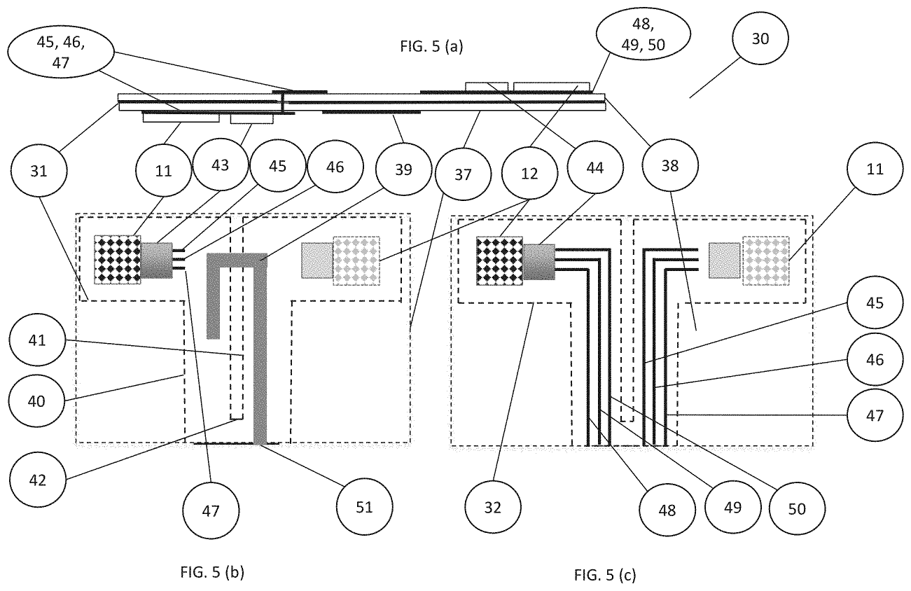

FIG. 5 shows a further embodiment of the disclosure whereby millimeter-wave arrays 11, 12 are arranged on the two conductive limbs 31, 32 of a dipole radiator 30 operating in a sub-6-GHz frequency range. The dipole comprises limbs 31, 32 and a galvanically-connected parallel transmission line stub formed by planar conductive members 40, 41, 42 on a first surface of dielectric lamina 37. A microstrip feed line 39 is formed on a second surface of dielectric lamina 37. The feed line 39 together with the transmission line stub 40, 41, 42 forms a so-called

Roberts' or hairpin balun. The feed line 39 is excited at microstrip input 51. In one embodiment, the thickness can be 0.15 mm or in certain cases, it can be etched on a standard PCB material with a thickness of 0.78 mm.

As best shown in FIG. 5(a), the dipole assembly 30 has the first dielectric lamina 37, the second dielectric lamina 38, and a circuit layer. The first and second dielectric lamina 37, 38 are thin planar members with first and second flat surfaces. The first dielectric lamina 37 has a first surface that faces outward. The first array 11, first circuit 43, and feedline 39 are mounted on the first outward surface of the first dielectric lamina 37. The first dielectric lamina 37 also has a second surface that faces inward, opposite the first surface. The second dielectric lamina 38 has a first surface that faces outward. The second array 12, second circuit 44 and lines 45-50 are mounted on the first outward surface of the second dielectric lamina 37. The second dielectric lamina 38 also has a second surface that faces inward, opposite the first surface.

The first lamina 37 is parallel to and aligned with the second lamina 38. Accordingly, the first outwardly-facing surface of the first lamina 37 faces in an opposite direction (away from) than the first outwardly-facing surface of the second lamina 37. And the second inwardly-facing surface of the first lamina 37 faces toward the second inwardly-facing surface of the second inwardly-facing surface of the second lamina 38.

In addition, the first and second limbs 31, 32 are sandwiched between the first and second lamina 38. Thus, the second inwardly-facing surface of the first lamina 37 contacts one side of the limbs 31, 32, and the second inwardly-facing surface of the second lamina 38 contacts a second opposite side of the limbs 31, 32. The limbs 31, 32 extend at least partially along the length and width of the lamina, and can extend the entire length and/or width of the lamina 37, 28.

A first millimeter-wave antenna array 11 and associated electronics circuit arrangements 43 are provided on the second face of lamina 37. Millimeter-wave array 11, circuit arrangements 43 and dipole limb 32 are arranged such that array 11 and circuit arrangements 43 occupy part of the same projected area as dipole limb 31. That is, the limbs 31, 32 are dimensioned to operate in a sub 6-GHz frequency range. The array 11, 12 and circuit element 43, 44 are aligned with the limbs 31, 32, respectively, and do not overhang their edges. In this way dipole limb 31 functions as a reflective groundplane behind millimeter-wave antenna array 11.

A second millimeter-wave antenna array 12 is provided on a second dielectric lamina 38 together with associated electronics circuit arrangements 44. Millimeter-wave array 12, circuit arrangements 44 and dipole limb 32 are arranged such that array 12 and circuit arrangements 44 occupy part of the same projected area as dipole limb 32. In this way dipole limb 32 functions as a reflective groundplane behind millimeter-wave antenna array 12.

One or more of each of microstrip lines 45, 50, power feeds 46, 49 or data connections 47, 48 may be made to electronic circuit arrangements 43, 44 respectively which may be integral with arrays 11, 12 or operatively connected thereto. Microstrip line 45, power feed 46 and data connection 47 may pass though lamina 38 by means of plated though holes or other connection methods.

It will be understood that the arrangement comprising dielectric laminae 37, 38 together with conductors formed on the faces thereof may be manufactured by printed circuit techniques including etching and lamination, the whole forming a 3-layer printed circuit assembly. Laminae 37, 38 are preferably formed from a low-loss dielectric material, typically between 0.3 mm and 1 mm thick but may be of the same or different dielectric material and thickness, for example a PTFE-glass laminate or a high grade resin-glass laminate such as Isola 370HR. Feed-through arrangements such as plated-through holes may be provided for conductive lines 45, 46, 47.

The millimeter antenna arrays 11, 12 may be positioned on first and second outwardly-facing sides of the dipole assembly 30 as shown in FIG. 5. Or, the arrays 11, 12 can be positioned outwardly facing on the same face. The direction of maximum radiation (beam direction) of each of the millimeter-wave antenna arrays 11, 12 may be fixed by design or may be controlled by the electronic circuit devices 43, 44, optionally in response to signals from user equipment and/or by external signals provided by control circuit devices and transmitted by data connections 47, 48. The millimeter-wave arrays 11, 12 together with circuit arrangements 47, 48 may provide MIMO or other advanced signal control and processing functionalities.

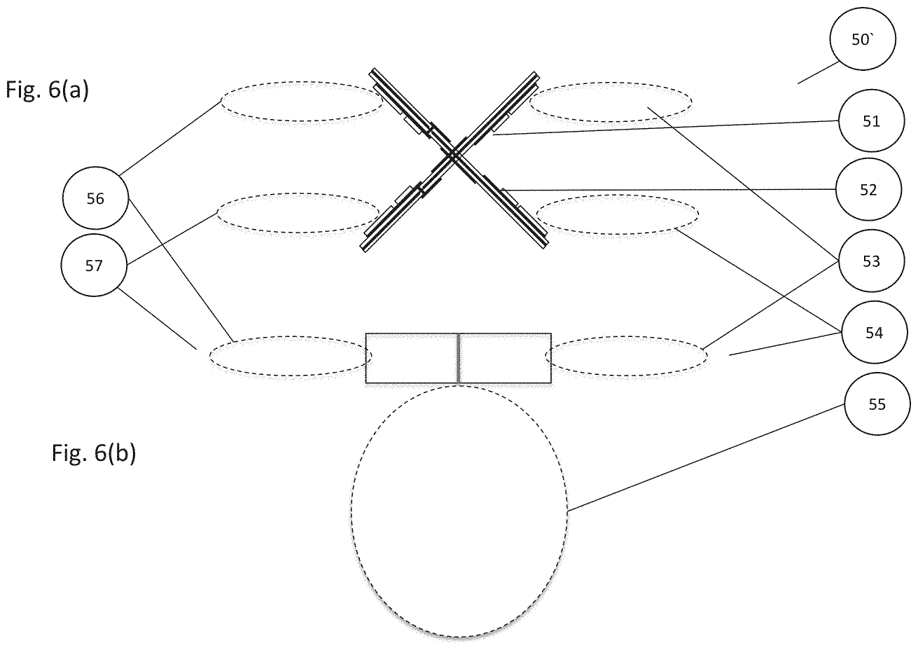

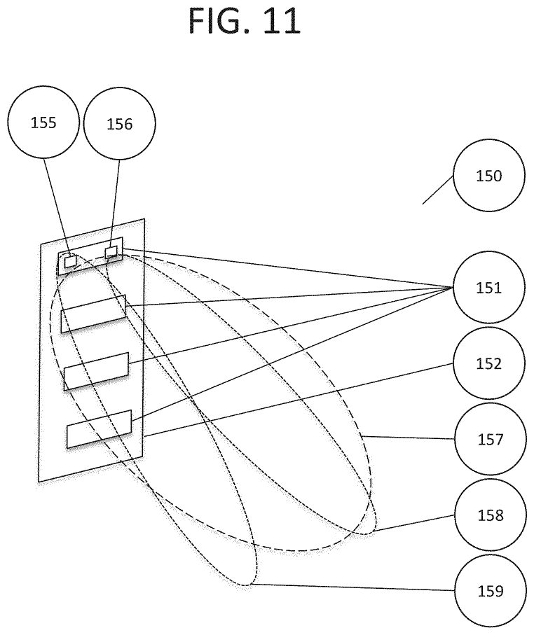

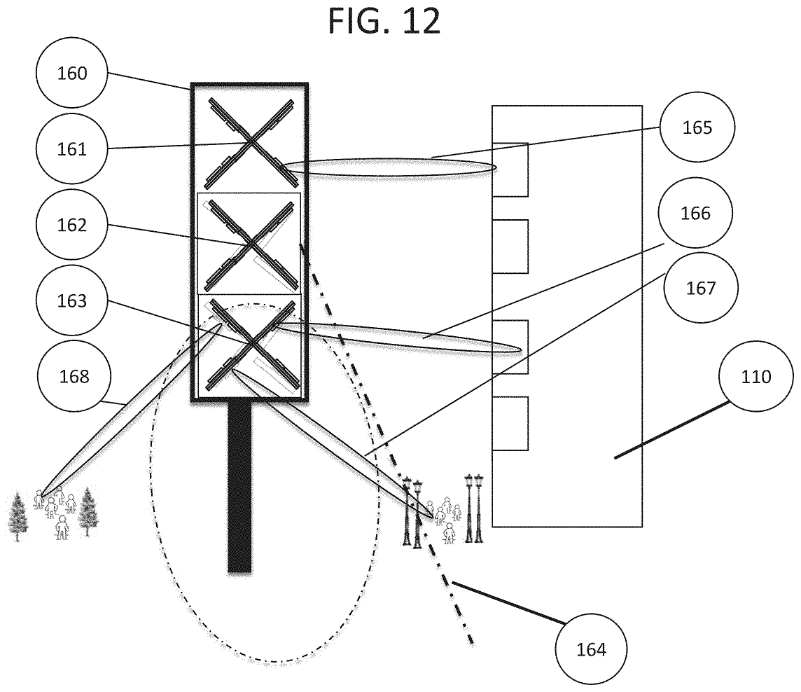

Millimeter-wave arrays 11, 12 are independent of one another; their electrical and mechanical parameters are independently chosen by design and they may operate in the same or different frequency bands. Beams formed by the millimeter-wave arrays 11, 12 may be aligned orthogonal to the plane of the supporting lamina or may be steered to any required direction relative to the orthogonal direction in accordance with prior art methods. The steering angle may be fixed or may be varied, for example in response to traffic requirements. The dipoles may be combined in the form of crossed dipoles as shown in FIG. 6, which may then be formed into arrays as shown in FIG. 11 and FIG. 12.

FIG. 6(a) shows a typical crossed-dipole configuration, herein dipole assemblies 51, 52 are arranged to form a crossed dipole operative in a sub-6-GHz frequency range and providing beam 55. The dipole assemblies 51, 52 can each be similar to the assembly 30 of FIG. 5 (although the assembly 30 of FIG. 5 can be applied to a window pane, it is especially designed for use in more complex arrays such as FIGS. 6, 11 and 12). By arranging that the beam direction of the millimeter-wave antenna arrays is directed at 45 degrees to the planes of dipole assemblies 51, 52, the millimeter-wave arrays provide beams 53, 54, 56, 57 in substantially horizontal directions, as shown in FIG. 6(b). These beam directions may be further adjusted to suit operational requirements as discussed above.

A sub-6-GHz base station antenna array may comprise a plurality of dipole assemblies, at least one of which may be arranged as the dipole assembly 30 (FIG. 5) to operate concurrently in a sub-6-GHz frequency range and a millimeter-wave frequency range.

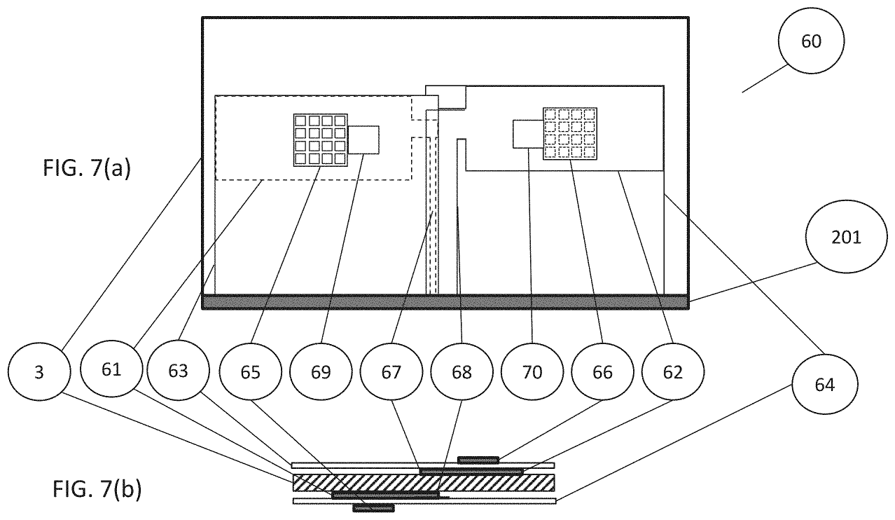

FIGS. 7(a), 7(b) show a further aspect of the disclosure adapted for window mounting. Here, a sub-6-GHz dipole antenna 60 has elongate planar conductive limbs 61, 62 which are formed on first surfaces of dielectric laminae 63, 64. Millimeter-wave antenna arrays 65, 66 are arranged on second faces of laminae 63, 64 such that they are aligned within the perimeter of dipole limbs 61, 62 respectively. The proximate ends of dipole limbs 61, 62 are excited by elongate planar feed conductors 67, 68. Feed conductor 68 may be laterally wider in extent than feed conductor 67 and may be operatively connected to an elongate planar conductive strip 201 aligned with an edge of the window pane. Conductive strip 201 may have a width between 5 mm and 30 mm and may be positioned along or proximate to an outer edge of a sealed multi-layer glass assembly forming a window pane 3 such that it is hidden when the window is installed. Alternatively strip 201 may be positioned such that it remains visible after installation.

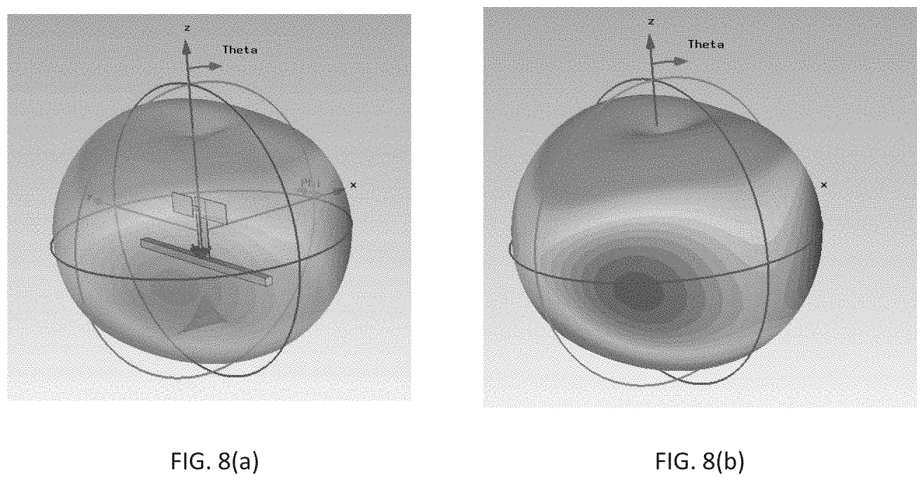

Feed conductors 67, 68 operate as a microstrip transmission line providing an electrically unbalanced feed to dipole limbs 61, 62 thereby creating a radiation pattern such as simulated in FIG. 8. The unbalanced geometry of the transmission line formed by conductive elements 67, 68, together with direct feeding of the dipole 61, 62 with no balanced-to-unbalanced transition (balun) between the transmission line 67, 68 and the proximate ends of dipole limbs 61, 62 results in excitation of radiating currents both in the dipole limbs 61, 62 and also in the feed conductor 68, thereby creating the quasi-isotropic radiation pattern of FIG. 8. The quasi-isotropic radiation pattern reduces the chance that a user is situated in a null of the radiation pattern as may occur with a more directional antenna.

As shown in FIG. 7(b), the laminae 63, 64 are mounted on first and second faces (the second face being on an opposite side to the first face) of a window pane 3. Here, the dipole elements are proximate to a face of the window pane and feed arrangements 67, 68 on dipole limbs 61, 62 are mutually aligned.

Millimeter-wave arrays 65, 66 are independent of one another, their parameters are independently chosen by design and they may operate in the same or different frequency bands. A plurality of sub-6 GHz dipoles may be configured to operate together with the first dipole, forming at least one sub-6 GHz antenna array. A plurality of millimeter-wave antenna arrays may be provided and each aligned in a corresponding manner with a sub-6 GHz dipole arm.

Substrates 63, 64 are preferably formed from low-loss dielectric material, typically 0.3 mm thick, having the dipole radiating elements formed on a first face and a millimeter-wave antenna array formed on a second face. The millimeter-wave arrays may be pre-manufactured as discrete components or formed on the substrates 63, 64 using an etching or printing process.

It will be understood that the structure here described by way of example may be realized using alternative materials and processes.

In the arrangement of FIG. 7 the sub-6 GHz dipoles have no reflective groundplane, so they scatter signals both towards an external base station and towards a user within the building. An array comprising identical dipole elements will form beams inside and outside the window whose directions are substantially collinear. The direction of beam maximum inside the window may be adjusted relative to the direction of the incoming signal by choosing the relative lengths of the dipoles or adding inductive or capacitive reactance across the terminals of each dipole. Longer or inductively loaded dipoles support currents with lagging phase relative to the incoming wavefront, while shorter or capacitively loaded dipoles support currents with leading phase relative to the incoming wave.

If the sub-6-GHz dipole of FIG. 7 is connected to a transmitter, it will transmit signals both inside and outside the window. An array of such dipoles will form directional beams inside and outside the window according to well-known antenna array theory.

Each millimeter-wave array 65, 66 operates in conjunction with a reflective groundplane formed by a conductive element of a sub-6 GHz dipole and provides a unidirectional beam. Arrays outside the window pane provide connection with a remote base station, while arrays inside the window pane provide service to users within the building.

FIG. 8 shows simulated radiation patterns for the configuration shown in FIG. 7. It will be seen that these are substantially omnidirectional in both azimuth and elevation planes, increasing the uniformity of service coverage within a building.

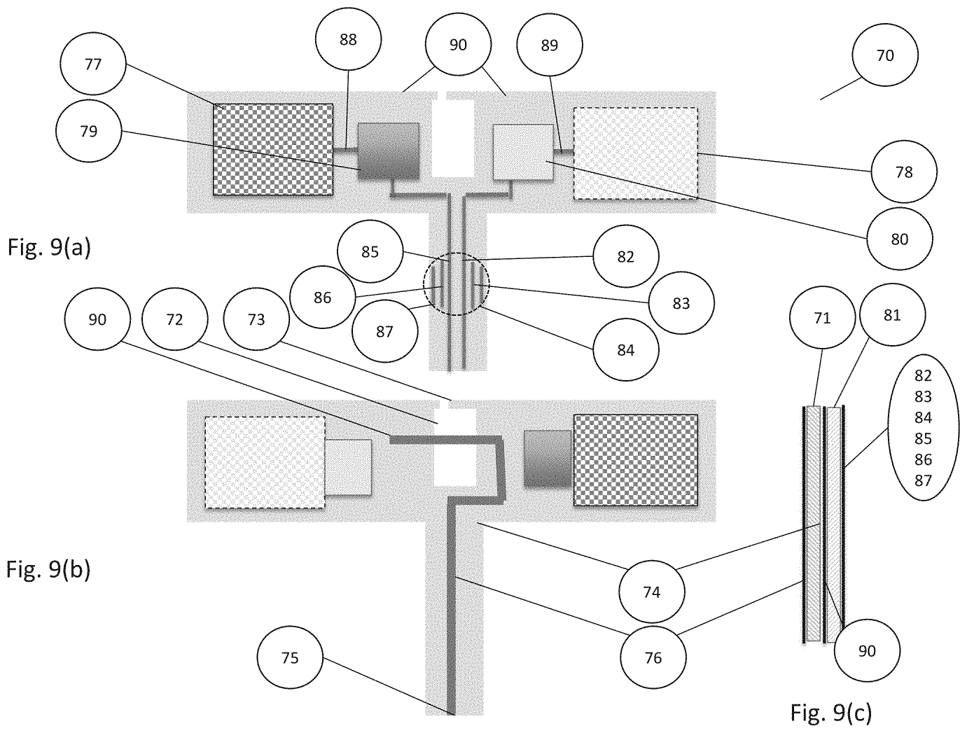

FIGS. 9(a), 9(b) show a further implementation of the disclosure wherein a dielectric lamina 71 is provided on a first face with an elongate conductive layer 90 whose long axis is approximately one-half wavelength at a sub-6-GHz operating frequency range. The assembly of FIG. 9 can be applied to a window pane, but is especially designed for use in more complex arrays such as FIGS. 6, 11 and 12.

An opening 73 is provided between an aperture 72 formed within conductive layer 90 and a proximate edge of conductive layer 90. The aperture 72 and opening 73 are preferably located substantially centrally along the long edge of conductive layer 90. The conductive layer 90 forms a continuous shunt-excited dipole, fed by a conductive strip 76 formed on a second face of lamina 71, extending from input 75 to open circuit 90 at the end of a stub extending across opening 72. The dipole is excited by the voltage across the opening 73. The feeding arrangement is related to a notch antenna and is further described in further detail in WO2015011468A1.

Conductive tracks supported on an outward-facing side of dielectric lamina 81 provide one or more of each of microstrip transmission lines 82, 83, power feeds 84, 85 and data connections 86, 87 to electronic circuit arrangements 79, 80, these being further connected to the millimeter-wave antenna arrays 77, 78 by transmission lines 88, 89. Lines 83, 84, 86, 87 are shown only in part but should be understood to extend as shown in full for lines 82, 85.

Millimeter-wave arrays 77, 78, together with associated electronic circuit arrangements 79, 80 are positioned on outwardly facing sides of laminae 71, 81. It will be understood that arrays 77, 78 may be placed on either outward sides of the arrangement and the associated electronics circuits may be positioned alongside the arrays as shown or may be positioned on the other outward face of the assembly 90. The microstrip transmission lines 82, 83, power feeds 84, 85 and data connections 86, 87 may be connected through the laminae 71, 81 by through-plated holes (vias), conductive pins or other arrangements. In this way, although lines 82-87 and feed line 76 are on first and second faces of the assembly 90, the millimeter-wave antennas and their associated electronics circuit arrangements may be positioned independently on either or both faces of the assembly 70.

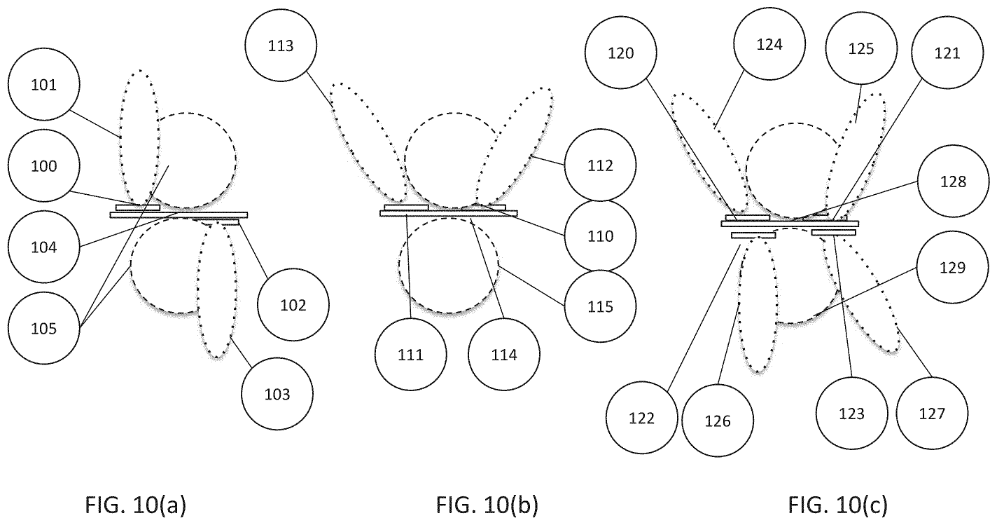

FIG. 10 shows examples of possible arrangements using combined sub-6-GHz and millimeter-wave antenna arrays according to FIG. 5 or 9 of the disclosure wherein the sub-6-GHz antenna comprises one or more dipoles having no reflector provided to create unidirectional beams. The directions of the millimeter-wave beams are indicated only by way of example; their direction may be static, controlled by external control signals or may be dynamically variable, for example by using MIMO beam forming or other advanced signal processing methods. It will be understood that further functionality may be obtained by arranging an antenna group comprising more than one sub-6-GHz antenna, each having associated millimeter-wave antenna arrays arranged thereon. The arrangements in FIGS. 10(a), 10(b) and 10(c) may also be used to provide relaying, back-haul and front-haul functionalities.

FIG. 10(a) shows a repeater arrangement produced by arranging the electronic circuit arrangements associated with millimeter-wave antennas 100, 102 to provide bidirectional amplification between two arrays firing on substantially reciprocal azimuth bearings creating millimeter-wave beams 101, 103 together with sub-6-GHz dipole 104 producing bidirectional beam 105.

FIG. 10(b) shows a repeater arrangement produced by arranging the electronic circuit arrangements associated with the millimeter-wave antennas 110, 111 provide bidirectional amplification between two arrays creating beams 112, 113 on azimuth bearings separated by an angle of approximately sixty degrees together with sub-6-GHz dipole 114 producing bidirectional beam 115.

FIG. 10(c) shows an arrangement wherein a plurality of millimeter-wave arrays 120-124 are arranged on two faces of a sub-6-GHz antenna 128 providing millimeter-wave beams 124-127 on azimuth bearings chosen by design and bidirectional sub-6-GHz beam 129.

FIG. 11 shows a sub-6-GHz base station antenna 150 comprising a plurality of radiating dipole elements 151 forming an array in front of a reflector 152 and providing a substantially unidirectional radiation pattern 157. A plurality of millimeter-wave antenna arrays 155, 156 providing radiation patterns 158, 159 is arranged on at least one of the sub-6-GHz dipole elements. It will be understood that in place of simple dipoles as described above, the sub-6-GHz radiating elements 151 may take the form of crossed dipoles or other configurations. The number of sub-6-GHz dipoles shown, and the number of millimeter-wave ante a Counted thereon are by way of example only. Practical antennas may comprise more than one sub-6-GHz array, operative in different sub-6-GHz frequency ranges.

FIG. 12 shows an example of a base station antenna 160 comprising an array of three sub-6-GHz crossed dipole elements 161, 162, 163 supporting millimeter-wave antenna arrays as shown in FIG. 6. The sub-6-GHz array creates a broad directional beam 164, typically directed downwards by between 5 and 20 degrees below the horizontal. Millimeter-wave beams 165, 166, 167, 168 are directed at current users and may be redirected or divided according to user demand for service.

The disclosure utilizes various reflective surfaces, for example the reflective groundplanes such as the conductive members 10 (FIG. 4), 31, 32, 40 (FIG. 5), 61, 62 (FIG. 7), 71 (FIG. 9) dipole 104 (FIG. 10), and reflector 152 (FIG. 11). The term reflective groundplane as used in the present disclosure generally refers to a substantially planar conductive member whose principal function is to reflect radio waves emitted by a radiating element such as a dipole or patch antenna. The action of such a groundplane may provide an image of a plurality of radiating elements affixed thereto or o otherwise modify the configuration of the electromagnetic fields radiated thereby.

The electronic circuit arrangement required to interface to external communications circuits and to convert signals to radio frequency signals for transmission from the antennas may be contained within the structure of the antenna 160 or may be external thereto. External communication may be provided by connected coaxial cables, optical fibers and/or at least one of the sub-millimeter antennas. The arrangements may be used to provide relaying, back-haul and front-haul functionalities, as well as providing high-capacity fixed wireless access to premises not served by optical fiber or other high capacity fixed data services. In such an application the service to users may be connected through a local communications network such as Ethernet, or a wireless local area network (WLAN).

For some applications it may be advantageous to feed the sub-6 GHz and millimeter-wave antennas through a filter system (diplexer) to reduce the number of external ports on an antenna.

The foregoing description and drawings should be considered as illustrative only of the principles of the disclosure, which may be configured in a variety of shapes and sizes and is not intended to be limited by the embodiment herein described. Numerous applications of the disclosure will readily occur to those skilled in the art. Therefore, it is not desired to limit the disclosure to the specific examples disclosed or the exact construction and operation shown and described. Rather, all suitable modifications and equivalents may be resorted to, falling within the scope of the disclosure.

1. An antenna assembly comprising:
a plurality of first radiating elements and associated electronic circuit arrangements forming a first antenna array operational in at least an upper frequency range; and
a conductive plane formed by a second radiating element operational in a lower frequency range, wherein said conductive plane functions as a reflective groundplane for the first antenna array.

2. The assembly of claim 1, wherein the first antenna array is affixed to the conductive plane.

3. The assembly of claim 2, wherein the electronic circuit arrangements comprise one or more of bidirectional amplifiers, power amplifiers, low-noise amplifiers, signal processing, signal conditioning, filtering or control functionalities, and wherein the electronic circuit arrangements are proximate to the first radiating elements and are supported by the second radiating element.

4. The assembly according to claim 1, wherein the second radiating element is within an array of radiating elements forming a second antenna array operative in the lower frequency range.

5. The assembly according to claim 1, wherein the second radiating element comprises a dipole excited by a radio frequency transmission line.

6. The assembly according to claim 1, wherein the first antenna array relays radio signals.

7. The assembly according to claim 1, wherein the first antenna array converts data received and retransmitted by radio signals to data received and transmitted by other media.

8. The assembly according to claim 1, wherein the second radiating element is configured to be affixed to a window.

9. The assembly according to claim 8, wherein the second radiating element is excited in an unbalanced mode with respect to an elongate conductive member positioned along or proximate to the edge of a window.

10. The assembly according to claim 1, wherein the second radiating element is a passive element.

11. The assembly according to claim 1, wherein the upper frequency range is for the transmission of signals in a public or private radio network supporting fixed or mobile users.

12. The assembly according to claim 1, wherein the upper frequency range is for the transmission of signals providing a local area communications network.

13. The assembly according to claim 1, wherein the second radiating element is excited in an unbalanced mode with respect to an elongate conductive member at least a portion of which is proximate to the edge of a window.

14. The assembly according to claim 1, wherein the upper frequency range and/or lower frequency range is for the transmission of radio signals in a mobile radio network.

15. An antenna assembly comprising:
a conductive plane operating in a first frequency range; and
one or more radiating elements positioned on or coupled to said conductive plane, said one or more radiating elements operating in a second frequency range different than the first frequency range.

16. The antenna assembly of claim 15, wherein said conductive plane comprises a dipole.

17. The antenna assembly of claim 15, wherein said one or more radiating elements comprise an antenna array.

18. The antenna assembly of claim 15, wherein said first frequency range comprises millimeter-wave frequencies, and said second frequency range comprises sub-6 GHz frequencies.

19. A method for communicating signals, comprising:
communicating by a conductive plane, signals at a first frequency range; and
communicating by one or more radiating elements positioned on the conductive plane, signals at a second frequency range different than the first frequency range.

20. The method of claim 19, wherein the conducting plane is a dipole antenna.
